(19) United States
(12) Patent Application Publication
(10) Pub. No.: US 2005/0289338 A1
(43) Pub. Date: Dec. 29, 2005

(54) Recording, editing, encoding and immediately distributing a live performance

(76) Inventor: Braden Stadlman, Roseville, MN (US)

Correspondence Address: Schwegman, Lundberg, Woessner & Kluth, P.A., P.O. Box 2938, Minneapolis, MN, 55402, US

(21) Appl. No.: 11/051,246

(22) Filed: Feb. 4, 2005

Related U.S. Application Data
(60) Provisional application No. 60/541,706, filed on Feb. 4, 2004.

(51) Int. Cl. G06F 7/00

(52) U.S. Cl. 713/153

(57) ABSTRACT

An audio and/or video signal is captured to a storage area network giving real time, simultaneous access to multiple users of the recorded data. The data is manipulated (i.e. mixed, remixed and mastered for optimization for distribution). The data is transmitted, wired or wirelessly, to a media duplication device (s) for immediate, on demand distribution.

### CO-PENDING PATENT APPLICATION

This patent application claims priority benefit under Title 35, United States Code, section 119(e). The entire subject matter of U.S. Provisional Patent Application Ser. No. 60/541,706 filed Feb. 4, 2004 and entitled METHOD FOR SIMULTANEOUSLY RECORDING, EDITING AND ENCODING A LIVE PERFORMANCE (attorney reference number 1936.001PRV) by inventor Braden Stadlman, is hereby incorporated by reference.

### COPYRIGHT NOTICE

This patent document contains copyrightable computer software elements and may include, but are not limited to, source code, flow charts and screen displays. The following notice shall apply to these elements: Copyright© 2004-2005 Moving Records, LLC, Minneapolis, Minn. All rights reserved.

### LIMITED WAIVER OF COPYRIGHT

A portion of the disclosure of this patent document may contain material to which a claim for copyright is made. The copyright owner has no objection to the facsimile reproduction by anyone of the patent document or the patent disclosure as it appears in the United States Patent and Trademark Office patent file records, as long as the above Copyright Notice remains legible on all copies. The copyright owner reserves all other national and international copyright rights.

### TECHNICAL FIELD

Various embodiments described herein relate to the field of recording and communicating information generally, including apparatus, systems, and methods for recording, editing and distributing live performances.

### BACKGROUND INFORMATION

Live performances or other live events are often recorded while the performance is occurring. Sometime after the occurrence of the live event, the video or audio content may be edited and packaged for sale to the public. The time between the live performance and the distribution of the edited content to the public is considerable and measures on the order of weeks, months or years after the live event.

Some recordings of live events have been made and later sold to the public but as the time between the live performance and the distribution of the recording of the live performance shortens, the quality diminishes proportionately. Also, the technical complexity and portability limits the cost effectiveness of such efforts as exemplified in U.S. Pat. No. 6,614,729. Therefore, there is a need in the industry for a real-time or near real-time recording, editing and mastering apparatus and a related method of distribution of recordings of a live event in a cost effective, high-speed and high quality fashion.

### BRIEF SUMMARY OF THE INVENTION

Some embodiments of the present invention include apparatus, systems, and methods for recording, editing and distributing recordings of live performances or live events while the event is still occurring or shortly thereafter and distributed to event attendees before they leave the site of the live event. The success of such a distribution model requires that the cost, quality and timeliness of the recorded content. Further, the success of such a business method requires the ability to simultaneously edit multiple portions of the recording and copy large quantities of the recordings in as short a time as possible

Embodiments of the present invention include a process and equipment by which audio and/or video signals from a live event are digitized and stored as digital data in a Storage Area Network (SAN). This allows real-time, simultaneous access to multiple users of the recorded data. The digital data is manipulated, mixed, remixed and mastered for recording onto a recording media, such as music and/or video CD or DVD disks, for distribution. The data is transmitted to a media duplication device for immediate, local and on-demand sale and distribution.

The SAN is connected to various nodes which all access the digital data. All connections throughout the SAN between nodes and servers can be wired or wireless communication connections. By way of example, the network connects to one or more recording nodes. A recording node initially receives and digitizes the audio and/or video signals from cameras and/or microphones used to capture a live performance or event. The SAN server stores the digitized signals into a storage node in uniquely identifiable files. The data in these files are immediately and simultaneously accessible to other nodes connected to the SAN as the signals are being recorded.

One or more editing nodes are also connected to the storage node to edit the content of the digital files simultaneous with the recording by the recording node. The editing nodes edit the digitized performance data stored in the uniquely identifiable files and creates optimized files for encoding into a format suitable for duplication. An encoding node is also connected through the SAN to the storage node and operates to encode the optimized files into a format acceptable for distribution. Such formats include, but are not limited to, CD, DVD, SACD, MP3, FLAC, WAV, streaming audio or video, other types of optical storage media, wireless distribution, internet download or transfer, etc.

In one embodiment, the encoded or optimized file is transmitted from the SAN to any number of distribution nodes connected to the SAN or to other networks which receive the encoded files containing the content from the live performance. These distribution nodes contain multiple media duplication devices consistent with venue size and/or customer demand.

Presently limited by available technology, it is conceivable that a single workstation may be constructed to accommodate each discrete node required to process the data to completion in software, hardware or a combination of both,

### BRIEF DESCRIPTION OF THE DRAWINGS

In the drawings, where like numerals refer to like components throughout the several views:

FIG. 1 is a block diagram of a network apparatus and a system according to various embodiments of the present invention;

FIG. 2 is a block diagram illustrating a plurality of nodes of the network of FIG. 1;

FIG. 3 is a block diagram of various media creation of the content an article according to various embodiments.

FIG. 4 is a block diagram illustrating nodes on an extended network shown in FIG. 1,

FIG. 5 is an illustration of the method of distribution for recordings of a live performance.

### DETAILED DESCRIPTION

In the following detailed description of the invention, reference is made to the accompanying drawings that form a part hereof, and in which is shown, by way of illustration, specific embodiments in which the invention may be practiced. These embodiments are described in sufficient detail to enable those skilled in the art to practice the invention. Other embodiments may be utilized and structural, logical, and electrical changes may be made without departing from the scope of the present invention. The following detailed description is, therefore, not to be taken in a limiting sense, and the scope of the present invention is defined only by the appended claims, along with the full scope of equivalents to which such claims are entitled.

The invention contained herein represents a marked improvement in the quality of live performance recordings and the speed at which a copy of the live recording can be distributed immediately following an event, both to attendees of the event and over the internet for download.

As of the date of this application the usual medium for distribution of music is the compact disc (CD), and for the distribution of video with sound is the digital video disc (DVD). However, there is an equally large market for sound and video files made available for download from the Internet in various computer file formats.

Most live music performances are amplified for the audience using multiple channels of analog and/or digital sound reinforcement techniques including microphones, electrified and amplified instruments. The signals captured during the performance are generally sent to a mixing console to set and equalize the sound levels of the independent voices and instruments. For many years live performances have been recorded for commercial and/or archival purposes.

Recording analog signals, such as those produced by microphones and traditional instrument amplifiers, has shifted in the last decade such that the industry standard has become to convert the analog signals to digital computer files. The advantage of a digitally recoded file is the facility of editing the digital signals in a non-destructive manner, whereas formerly, with recording tape, an edited signal destructively altered the tape.

In order to make any live recording commercially available, it must first be checked for quality and accuracy of the reproduction. Traditionally, in order to review the material for quality, edit the material (mixing), prepare it for commercial production according to industry standards (mastering), and encode the files for duplication, there is some period of delay, ranging from hours to weeks or months, before any recording of a live performance may be commercially available.

Utilizing currently available technology, the present invention combines computerized recording, mixing and mastering, and encoding on a single storage area network, where each process can be effected simultaneously and in real time during a live performance. In so doing a final, commercial quality recording can be completed within minutes after the conclusion of the show and can be manufactured and made available through multiple distribution channels and media. The combination of the quality of the final recording and the speed which it can be distributed constitutes an improvement on any existing prior art.

Additionally, the invention encompasses not yet available technology which facilitates even more rapid distribution methods by utilizing wireless connectivity between the nodes of the storage area network and ever increasing duplication and download speeds for distribution of the live recordings.

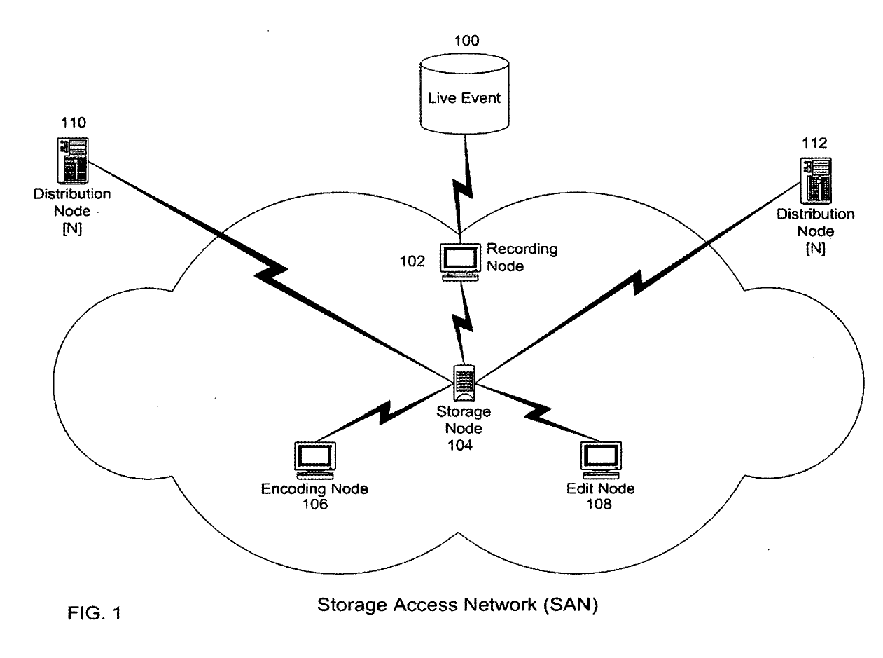

FIG. 1 is a block diagram of an embodiment of the components of the Storage Access Network (SAN). The live performance (100) is transmitted through a multi-channel communication device such as a digital/analog snake or wireless link. The signals enter the Storage Area Network (SAN) at the recording node and the performance signal is converted to a recordable and editable file format. Moreover, since the media segments are stored digitally, they can be randomly accessed, edited, and played back essentially instantly. (102). The recording node is comprised of an Apple Macintosh Dual Processor 2 GHz G5 running MacOS 10.3.2. A Pro Tools HD 2 Accel workstation with multiple Digidesign 192k I/Os is installed utilizing Digidesign Pro Tools 6.2.2. The Digidesign 192k I/Os convert the analog audio signal into digital signals that the Pro Tools workstation saves as editable files. The edit (108) and encoding (106) nodes are similarly equipped with the encoding node containing an additional Plextor Premium high speed 52× CDR/RW drive for creation of physical master copies. These three nodes are connected to a Vixel 9100 Fibre Fabric Switch via Apple Fibre Channel Host Bus Adaptors (HBAs) in each computer. The Vixel 9100 connects to the RAID controllers of a Studio Network Solutions A/V SAN Pro Disc Array. The Vixel 9100 Fibre Fabric Switch and A/V SAN Pro Disc Array make up the storage node (104). All nodes connected to the SAN utilize SANmp software version 1.0.6 by Studio Network Solutions. The recording node, edit node, encoding node and storage node comprise the Storage Area Network.

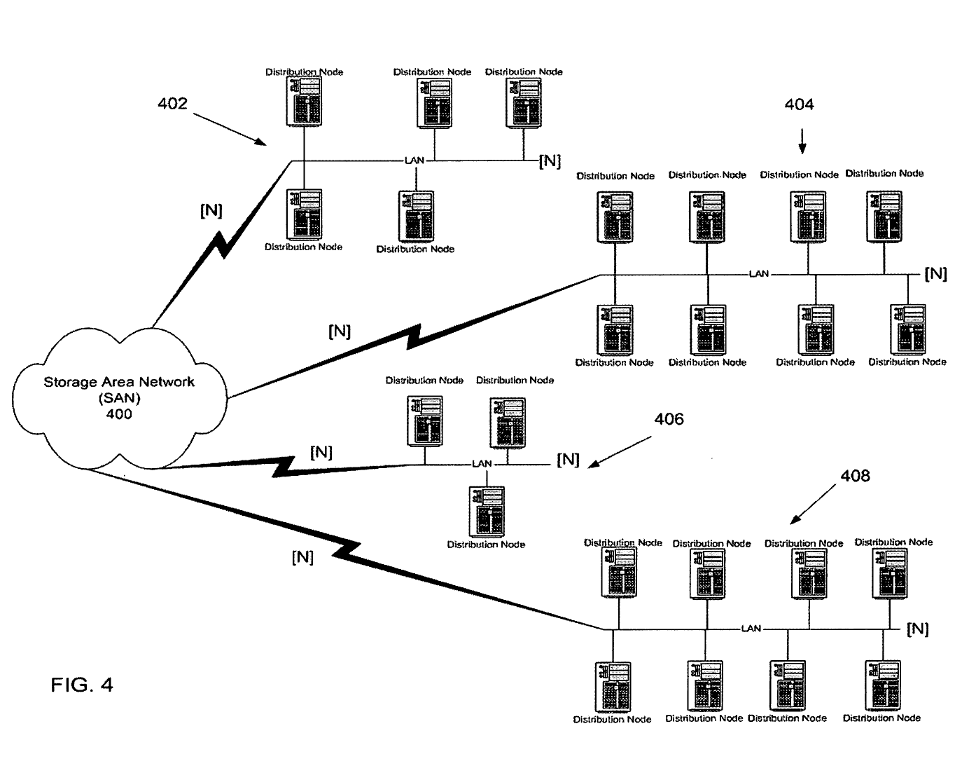

The distribution nodes (110-112) are controlled by Apple Macintosh G5 computers running MacOS 10.3.2 and Roxio Toast Titanium 6 software. The distribution node's Apple G5s are connected to arrays of Teac high speed 52× CDR/RW drives via Firewire 800 (IEEE 1394-b). The distribution nodes interface with the storage node to transmit disc images and other information wirelessly via IEEE 802.11g networking standards. In a wired network model the distribution nodes communicate with the storage nodes of the SAN via 2 Gb/s Fibre Channel or IEEE P802.3ae 10 Gb/s Ethernet through an appropriate switch which enables unlimited branching and networking of the distribution nodes. This branching is denoted by the variable [N] and illustrated in FIG. 4 shown below.

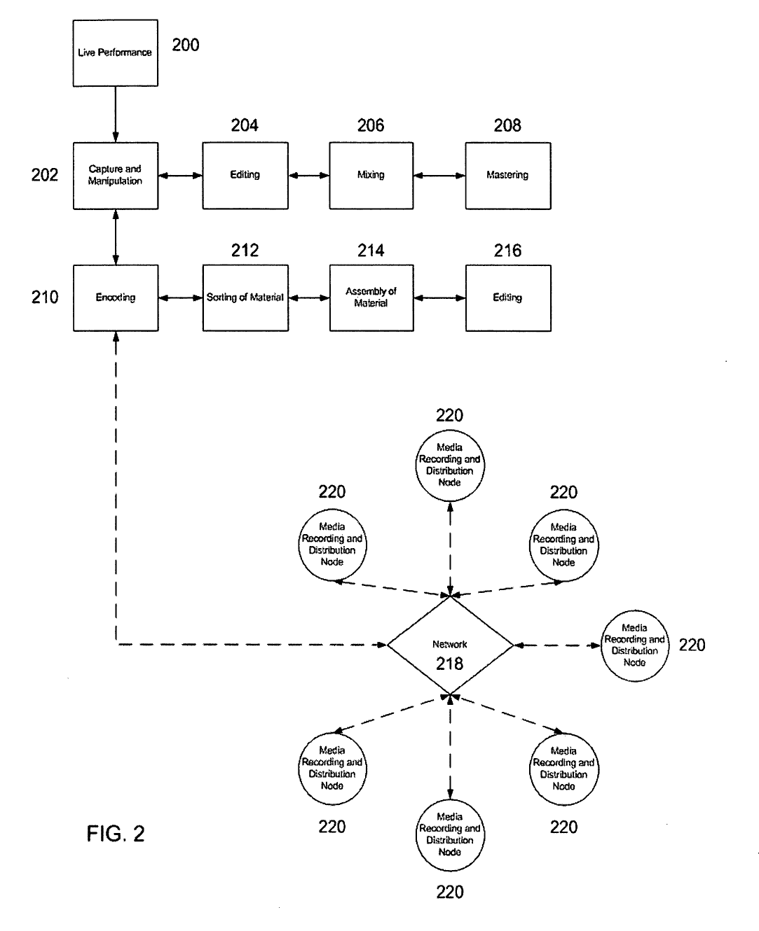

FIG. 2 (200) The live performance is transmitted through a multi-channel communication device such as a digital/analog snake or wireless link. In the manipulation and capture node (202) the performance signal is converted to a recordable and editable file format. Moreover, since the media segments are stored digitally, they can be randomly accessed, edited, and played back essentially instantly. The saved files are edited (204) for content and usefulness for the final product. The saved files from 202 are mixed together (206) and then mastered (208). Through the mastering process overall levels and sound quality is enhanced and adjusted. The mastered files are encoded (210) for final distribution by choosing what material will make the final product, arranging the tracks in proper order (214), and any final editing that may be necessary (216). All of the prementioned steps may be performed in any order or simultaneously by multiple human operators. Some steps may be altered or left out entirely. The final disc image is uploaded to the network (218) for creation by the distribution nodes (220).

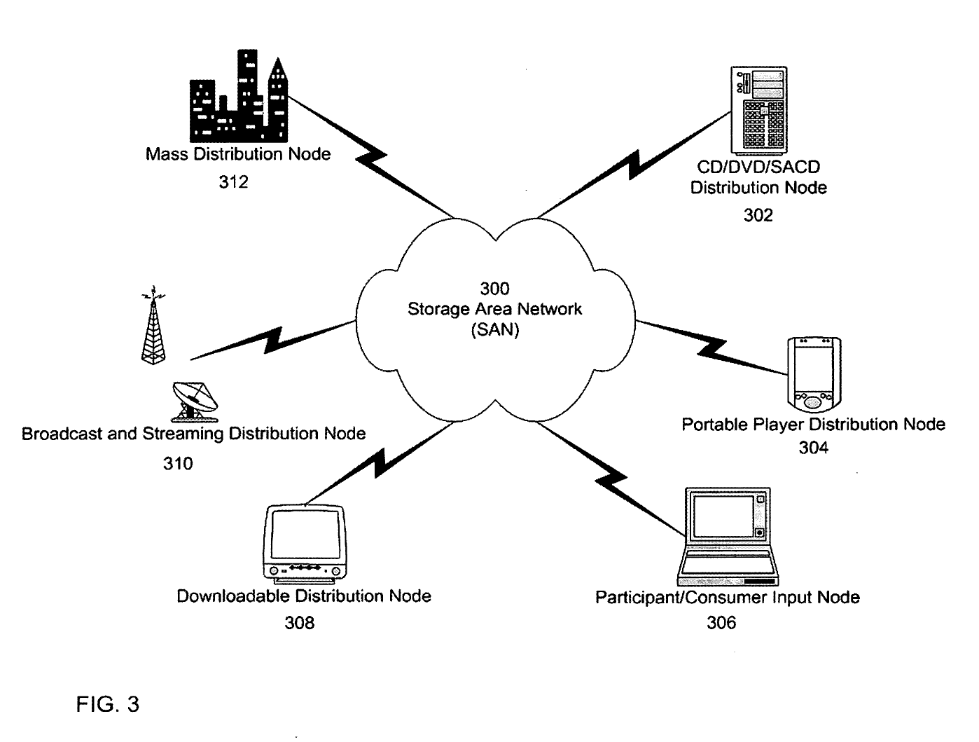

FIG. 3 The SAN (300) described in FIG. 1 can provide media creation for a multitude of varying outlets. The first embodiment of the invention is to create physical product on CD/DVD/SACD or similar media (302). In another embodiment the SAN can also act as a supplier to a network of portable player download locations such as iPods (304). In a third embodiment the SAN can receive information from event participants for inclusion onto the media that is being created for that event (306). In a fourth embodiment the SAN can serve multiple download formats such as AIFF, FLAC, MP3, AAC, etc. for customers regardless of geographic location to the event (308). In a fifth embodiment the SAN can provide a signal that is broadcastable and/or streamable in multiple formats including but not limited to Real Media, Windows Media, Quicktime Streaming, MP3, etc (310). In a sixth embodiment the SAN can create media that is able to be distributed to large numbers of customers such as commercially produced DVDs, CDs, Television, etc. (312).

FIG. 4 In another embodiment the SAN (400) can provide content for media creation to a multitude of distribution notes (402-408). FIG. 4 is a closer examination of detail 302. The variable [N] is used to denote the multiple branches and distribution nodes over a wired or wireless network.

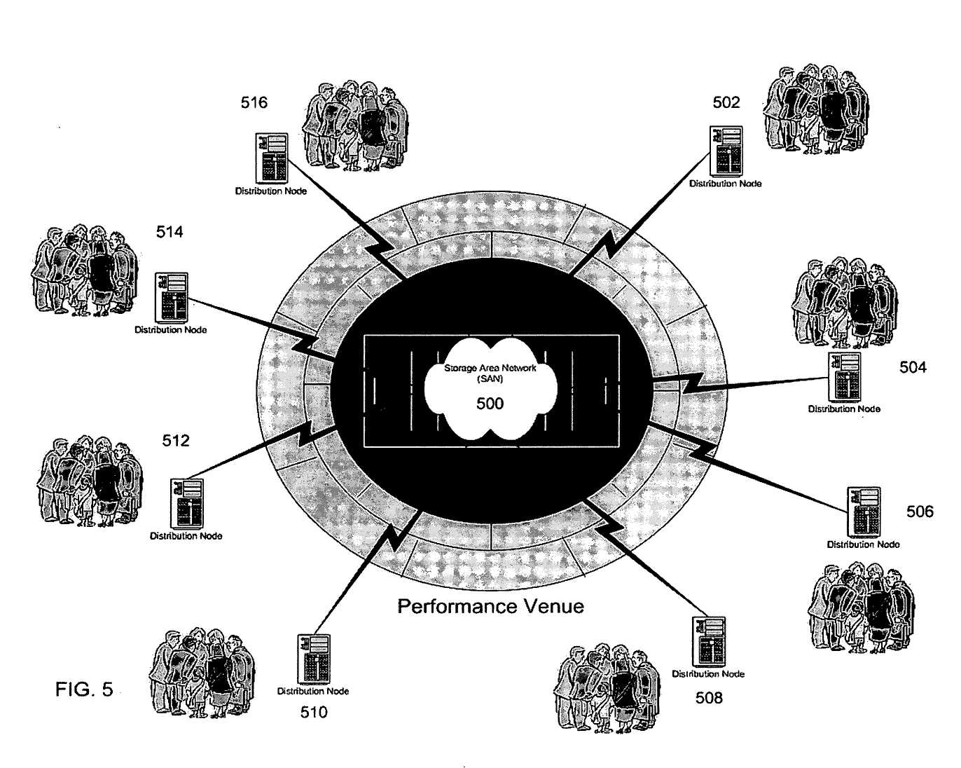

FIG. 5 The wide dispersion of distribution nodes in a venue is essential in providing customers with immediately available product. The SAN (500) does not have to be centrally located but a centralized location minimizes distances between distribution centers (502-516). The embodiment of this FIG. (5) shows a deployment of the network illustrated in FIG. 4.

This invention is applicable to any live performance or event containing live sound and/or video. This invention is appropriate and scalable for any size venue performance.

The current embodiment relies on using an IEEE 1394b bus for CD duplication connection. Up to 63 devices can be chained together and has a throughput of 800 megabits per second. Current hard drive throughput is 150 Megabytes per second utilizing Serial ATA (SATA) standards. As technology progresses flash based memory systems may provide a faster answer to problems of data throughput. Flash systems do not utilize mechanical systems to access information and are not limited by those systems. The data throughput of the media burners must not exceed the bus speed of the host or errors will occur due to an insufficient stream of data to the burner that will render the disc unusable. As more burners are added, the data throughput requirement increases. It is conceivable that other interfaces may be used such as SCSI, USB, USB2.0, and ATA/IDE but at the present time the combination of SATA and IEEE 1394 afford the greatest advantages.

The speed measurement of a CD recorder is how fast it can record data to blank CD-R media. Speed designators such as “4×” “20×” and “50×” are multiples of the original playback speeds of first generation CD-ROM players. For a CD-ROM player or CD recorder, a 1× speed translates to 153,600 bytes per second. This is rounded to 150K per second. So a “2×” recorder records at 300K per second, and a “50×” records at 7500K per second. There are some variations in measuring speed because there are no recording modes that provide more than 2048 data bytes per frame (audio is recorded at 2352 bytes per frame). Some CD recorders have a different reading speed than their recording speed. For instance a “10×/25×” CD recorder can write at 10× speed (1500K/sec) and read back at 25× speed (3750K/sec).

At a 52× burn speed, 150 K/sec×52=7800 K/sec throughput needed per drive. Since the IEEE 1394b interface is going to be the limiting interface based on throughput, the current maximum number of 52× CDR/RW drives that can be attached to each IEEE 1394b host bus adapter is 10. The recording speed is independent of playback speed. It is generally better to record at higher speeds. The physics, chemistry and thermodynamics of the recording process produce more consistent and readable marks within the CD-R recording layer.

In larger venues running cabling throughout the facility is not realistic. Utilizing wireless networking technology to provide data to the distribution centers is much more feasible than physically running wires. Because the bandwidth of wireless networking is smaller than most wired technologies such as gigabit Ethernet and IEEE 1394b, the time to transfer large CD sized data files (<600 Megs) is increased. Progressive burning is necessary to enable the creation of discs across a network at multiple distribution nodes. Progressive burning eliminates the need for large buffer size and large throughput requirements. The G5 that controls each distribution node acts as a receiver for the wireless communication as well as a buffer for the information that is being burned onto the discs. These features can be included in each array of high-speed duplicators in another embodiment. The buffer is necessary to guarantee a consistent and steady flow of data to each media recorder.

Instead of transferring the entire CD image to burn it all at once (commonly referred to as Disc at Once or DAO) the tracks can be copied one at a time as each track is completed (for CD-R recorders, this is commonly referred to as Track at Once or TAO). The use of TAO recording will mean that only one track must be recorded after the performance is concluded—reducing lag time between the end of the performance and the completion of the digital media recording process to a matter of a few seconds. In a situation where time is not as critical, DAO recording could be used since it provides a more stable recording environment and a smaller gap between tracks.

For example, if track number 1 (consisting of the audio recording of a four minute song) is currently available, but track number 2 will not be available for 4 minutes, an array of high-speed media duplicators can begin burning track 1 as a TAO file while track 2 is being created. Once track number 2 is available, the media duplicators can add track 2 to the discs containing track 1 (using TAO recording) while track number 3 is being processed. This process can be repeated until all the desired tracks are added to the CD. Once all the tracks are recorded on the disc the disc needs to be finalized.

When a disc is finalized, the absolute lead-in and lead-out for the entire disc is written, along with information which tells the reader not to look for subsequent sessions. This final table of contents (TOC) conforms to the ISO 9660 standard. CD-R writers support incremental packet writing. Using this mode data can be saved to a CD without finalizing a session or the CD so more data can be added to the CD at a later time. The CD can not be read in a CD-ROM player until it has been finalized.

Once all the information that needs to be included on the media is present, a command is sent over the network for the drives to finalize the data. After finalization is complete, the disc is ejected and transported to an area suitable for sale.

Another embodiment of the invention is a mobile recording studio containing the SAN (comprised of a recording computer, a storage computer, and an encoding computer) each computer in the network contains digital recording software operated by knowledgeable sound and video engineers. The mobile studio is given access to recordable signals within a reasonable distance from the stage where the live performance is to take place. During the performance, the audio signals are prepared for commercial distribution by the engineers in the mobile recording studio. Upon the conclusion of the live performance the recorded and encoded sound file (s) of the live performance generated by the engineers using the SAN is sent to various distribution nodes containing multiple high speed compact disc burners. The compact discs are burned at the remote distribution nodes upon demand by consumers. Simultaneously, the sound files are uploaded from the SAN storage node to a server capable of distributing the files via computer download on demand by consumers.

Another embodiment is obtaining a multi-channel signal from a mixing console that is connected to receive each audio signal being sent to the mixing board then broadcast to the attendees of the live performance. This signal can be combined with other signals that emanate from the performance to produce a commercial distributable product.

Another embodiment is for the SAN to be set up temporarily or permanently within the venue where the live performance will take place, with distribution nodes strategically located in the venue.

Another embodiment is for the SAN to be located at a remote location with strategically placed download terminals located in the venue.

A SAN and/or a connected network can collect information from attendees of event, such as, personal images, text, audio, and video for inclusion on distributed product via input nodes.

The resulting wired or wireless network can provide feedback such as sales information, transaction processing, and inventory information throughout the distributed network.

The SAN can be connected to other SANs in order to offer product from other events happening simultaneously.

It should be stated that anyone skilled in the art will realize that this process is adaptable for inclusion of future technologies both in media creation and content creation. It is foreseeable that video can be included into content creation as well as other forms of media. As data formats evolve the DVD and other standards will gradually replace the CD. Also, the DVD will be replaced by a superior format at some point and this trend will continue as new technology is created. This invention is not limited by the technologies currently available.

Various embodiments disclosed herein may address some of the challenges described above by using a Storage Area Network (SAN), described in more detail below, to simultaneously record, edit, master and encode a live performance using a storage area network, and immediately distributing the. recorded, encoded performance using any acceptable distribution method.

### CONCLUSION

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those skilled in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A mobile recording studio system, comprising:
a storage area network having:
a recording node having a computer running digital recording software, the node operable to produce digital data corresponding to real-time recordings of a live event at a venue;
a storage node having a computer connected to store the digital data and for providing simultaneous access to the digital data by other nodes on the storage area network;
an editing node having a computer connected to retrieve the digital data, for editing the content of the digital data simultaneous with the storing of the digital data and producing therefrom edited digital data, and storing the edited digital data into the storage node;
an encoding node having a computer connected to retrieve the edited digital data and for producing therefrom encoded digital data; and
a recording device connected to the storage area network to write the encoded digital data to playable media.

2. The mobile recording studio system according to claim 1, further comprising wireless connections between some of the nodes and the storage area network.

3. The mobile recording studio system according to claim 1, wherein the recording node is further operable for obtaining a multi-channel signal from a mixing console that is connected to receive an audio signal being sent to the mixing board then broadcast to the attendees of the live performance.

4. The mobile recording studio system according to claim 3, wherein the recording node is further operable for combining the multi-channel signal from the mixing console with other signals that emanate from the performance to produce a commercially distributable product

5. The mobile recording studio system according to claim 1 wherein the encoded digital data of the live event is sent to a plurality of distribution nodes containing multiple high speed compact disc burners.

6. The mobile recording studio system according to claim 1, wherein the encoded digital data are sound files of the event.

7. The mobile recording studio system according to claim 1 wherein the encoded digital data is uploaded from the storage node to a server capable of distributing the files via computer download on demand by consumers.

8. The mobile recording studio system according to claim 1 wherein the encoded digital data is sent from the storage area network to distribution or download terminals located in the venue.

9. The mobile recording studio system according to claim 1 wherein the editing node edits the content of the digital data and places the edited digital data into optimized files for encoding into a format suitable for duplication.

10. The mobile recording studio system according to claim 1 wherein the storage node stores the content of the digital data in uniquely identifiable files.

11. A method of distributing a recording of a live event, comprising:
recording sound or visual information at a live event at a venue;
converting the sound or visual information into digital data;
storing the digital data;
simultaneously accessing the digital data while the digital data is storing;
editing the content of the digital data to produce edited digital data;
storing of the edited digital data while simultaneously storing the digital data;
encoding the edited digital data to produce encoded digital data; and
writing the encoded digital data on a media.

12. The method according to claim 11 wherein the digital data is sent by a wireless connection.

13. The method according to claim 11 where writing the encoded digital data on a media includes writing the encoded digital data on a CD-ROM or DVD.

14. An article including a machine-accessible medium having associated information, wherein the information, when accessed, results in a machine performing:
recording sound or visual information at a live event at a venue;
converting the sound or visual information into digital data;
storing the digital data;
simultaneously accessing the digital data while the digital data is storing;
editing the content of the digital data to produce edited digital data;
storing of the edited digital data while simultaneously storing the digital data;
encoding the edited digital data to produce encoded digital data; and
writing the encoded digital data on to a playable media.
